(19) United States
(12) Patent Application Publication
(10) Pub. No.: US 2025/0131870 A1
(43) Pub. Date: Apr. 24, 2025

(54) PIXEL CIRCUIT

(71) Applicant: Samsung Display Co., LTD., Yongin-si (KR)

(72) Inventors: WONJUN LEE, Yongin-si (KR); Kyeongmin PARK, Yongin-si (KR); KWIHYUN KIM, Yongin-si (KR); YEONKYUNG KIM, Yongin-si (KR)

(21) Appl. No.: 18/895,076

(22) Filed: Sep. 24, 2024

(30) Foreign Application Priority Data
Oct. 19, 2023 (KR) 10-2023-0140733

(51) Int. Cl. G09G 3/32

(52) U.S. Cl. CPC G09G 3/32; G09G 2300/0842; G09G 2310/08; G09G 2320/064

(57) ABSTRACT

A pixel circuit includes a first transistor including a gate terminal which receives a first gate signal, a first terminal connected to a first node, and a second terminal connected to a second node, an inverter including a first sub-transistor including a gate terminal connected to the first node, a first terminal which receives a driving voltage, and a second terminal connected to the second node, and a second sub-transistor including a gate terminal connected to the first node, a first terminal which receives a ground voltage, a second terminal connected to the second node, and a light emitting element including an anode connected to the second node and a cathode which receives the ground voltage.

This application claims priority to Korean Patent Application No. 10-2023-0140733, filed on Oct. 19, 2023, and all the benefits accruing therefrom under 35 U.S.C. § 119, the content of which in its entirety is herein incorporated by reference.

### BACKGROUND

### 1. Field

Embodiments of the invention relates to a pixel circuit. More particularly, the invention relates to a pixel circuit for displaying an image using a pulse width modulation (PWM) method.

### 2. Description of the Related Art

Generally, a display device includes a display panel and a display panel driver. The display panel may include gate lines, data lines, and pixel circuits. The display panel driver may include a gate driver for providing gate signals to the gate lines, a data driver for providing a data voltage to the data lines, and a driving controller for controlling the gate driver and the data driver.

The pixel circuit may display an image using a pulse amplitude modulation (PAM) method or a pulse width modulation (PWM) method. The PAM method may express a grayscale by adjusting a pulse amplitude of a driving current flowing in the pixel circuit, and the PWM method may express the gray scales by adjusting a pulse width of the driving current.

### SUMMARY

In a display device using a pulse width modulation (PWM) method, a generation time of the driving current corresponding to the pulse width of the driving current may be important to express the grayscale. However, delay time may occur in a rising period of the driving current and a falling period of the driving current.

Embodiments of the invention provide a pixel circuit for displaying an image using a pulse width modulation method and reducing a delay time of a rising period of a driving current and a delay time of a falling period of the driving current.

In an embodiment of a pixel circuit according to the invention, the pixel circuit includes a first transistor including a gate terminal which receives a first gate signal, a first terminal connected to a first node, and a second terminal connected to a second node, an inverter including a first sub-transistor including a gate terminal connected to the first node, a first terminal which receives a driving voltage, and a second terminal connected to the second node and a second sub-transistor including a gate terminal connected to the first node, a first terminal which receives a ground voltage, a second terminal connected to the second node, and a light emitting element including an anode connected to the second node and a cathode which receives the ground voltage. In such an embodiment, the first sub-transistor is a P-type transistor and further includes a back gate terminal which receives a first back gate voltage, and the second sub-transistor is an N-type transistor and further includes a back gate terminal which receives a second back gate voltage.

In an embodiment, each of the first back gate voltage and the second back gate voltage may be equal to a voltage of the first node.

In an embodiment, the pixel circuit may further include a second transistor including a gate terminal which receives a second gate signal, a first terminal which receives a data voltage which includes a pulse width modulation data voltage and a sweep voltage, and a second terminal connected to a third node and a boost capacitor including a first terminal connected to the third node and a second terminal connected to the first node.

In an embodiment, an input terminal of the inverter may be connected to the first node and an output terminal of the inverter may be connected to the second node.

In an embodiment, a driving current may be generated based on the data voltage and a generation time of the driving current is determined depending on a voltage level of the PWM data voltage.

In an embodiment, the inverter may invert a voltage of the first node and output an inverted voltage of the first node to the second node.

In an embodiment, the inverter may reduce a delay time of a rising period of the driving current and a delay time of a falling period of the driving current.

In an embodiment, a threshold voltage of the first sub-transistor may be determined based on the first back gate voltage and a threshold voltage of the second sub-transistor may be determined based on the second back gate voltage.

In an embodiment, the threshold voltage of the first sub-transistor may increase when the first back gate voltage decreases.

In an embodiment, the threshold voltage of the second sub-transistor may decrease when the second back gate voltage increases.

In an embodiment, a delay time of a rising period of the driving current and a delay time of a falling period of the driving current may decrease when a difference between the threshold voltage of the first sub-transistor and the threshold voltage of the second sub-transistor decreases.

In an embodiment, the P-type transistor may be a polysilicon thin-film transistor and the N-type transistor may be an oxide thin-film transistor.

In an embodiment of a pixel circuit according to the invention, the pixel circuit includes a pulse width modulation circuit which generates a pulse width modulation (PWM) signal, where the pulse width modulation circuit includes an inverter including a first sub-transistor including a gate terminal connected to a first node, a first terminal which receives a driving voltage, and a second terminal connected to a second node, and a second sub-transistor including a gate terminal connected to the first node, a first terminal connected a third node, and a second terminal connected to the second node, and a driving current generating circuit which generates a driving current whose a generation time is determined based on the pulse width modulation signal, where the driving current generating circuit includes a light emitting element which emits a light based on the driving current. In such an embodiment, the first sub-transistor is a P-type transistor and further includes a back gate terminal which receives a first back gate voltage, and the second sub-transistor is an N-type transistor and further includes a back gate terminal which receives a second back gate voltage.

In an embodiment, each of the first back gate voltage and the second back gate voltage may be equal to a voltage of the first node.

In an embodiment, the driving current generating circuit may further include a first transistor including a gate terminal connected a fourth node, a first terminal which receives the driving voltage, and a second terminal connected to a fifth node, a second transistor including a gate terminal which receives a first gate signal, a first terminal connected to the fourth node, and a second terminal connected to the fifth node, and a third transistor including a gate terminal which receives the pulse width modulation signal output from the second node, a first terminal connected to a sixth node, and a second terminal connected a seventh node. In such an embodiment, the pulse width modulation circuit may further include a fourth transistor including a gate terminal which receives the first gate signal, a first terminal connected to the first node, and a second terminal connected to the second node, and the light emitting element includes an anode connected to the seventh node and a cathode which receives a ground voltage.

In an embodiment, the driving current generating circuit may further include a fifth transistor including a gate terminal which receives the first gate signal, a first terminal connected to a current source, and a second terminal connected to the fifth node, a sixth transistor including a gate terminal which receives a second gate signal, a first terminal connected to the fifth node, and a second terminal connected to the sixth node, and a storage capacitor including a first terminal which receives the driving voltage and a second terminal connected to the fourth node. In such an embodiment, the pulse width modulation circuit may further include a seventh transistor including a gate terminal which receives a third gate signal, a first terminal which receives the ground voltage, a second terminal connected to the third node and a boost capacitor including which receives a data voltage and a second terminal connected to the first node.

In an embodiment, an input terminal of the inverter may be connected to the first node and an output terminal of the inverter may be connected to the second node.

In an embodiment, the inverter may invert a voltage of the first node and output an inverted voltage of the first node to the second node.

In an embodiment, the inverter may reduce a delay time of a rising period of the driving current and a delay time of a falling period of the driving current.

In an embodiment, a threshold voltage of the first sub-transistor may be determined based on the first back gate voltage and a threshold voltage of the second sub-transistor may be determined based on the second back gate voltage.

In an embodiment, a delay time of a rising period of the driving current and a delay time of a falling period of the driving current may decrease when a difference between the threshold voltage of the first sub-transistor and the threshold voltage of the second sub-transistor decreases.

In an embodiment, the P-type transistor may be a polysilicon thin-film transistor and the N-type transistor may be an oxide thin-film transistor.

According to embodiments of the pixel circuit and the display device including the pixel circuit, the pixel circuit may include the inverter such that the delay time of the rising period of the driving current and the delay time of the falling period of the driving current may be reduced.

In such embodiments, the pixel circuit may adjust the first back gate voltage of the first sub-transistor included in the inverter and the second back gate voltage of the second sub-transistor included in the inverter such that the delay time of the rising period and/or the delay time of the falling period of the driving current may be further reduced.

Accordingly, a reliability of a grayscale implemented by the pixel circuit which displays an image using a pulse width modulation method may be increased.

### BRIEF DESCRIPTION OF THE DRAWINGS

The above and other features of embodiments of the invention will become more apparent by describing in detailed embodiments thereof with reference to the accompanying drawings, in which:

FIG. 1 is a block diagram illustrating a display device according to embodiments of the invention;

FIG. 2 is a circuit diagram illustrating an example of a pixel circuit included in a display panel of FIG. 1;

FIG. 3 is a circuit diagram illustrating another example of the pixel circuit included in a display panel of FIG. 1;

FIG. 4 is a timing diagram illustrating an example of driving the pixel circuit of FIG. 2;

FIG. 5 is a graph illustrating an ideal example of a driving current flowing into a light emitting element of FIG. 2;

FIG. 6 is a graph illustrating an actual example of the driving current flowing into the light emitting element of FIG. 2;

FIG. 7 is a circuit diagram illustrating an inverter of FIG. 2;

FIG. 8 is a circuit diagram illustrating a first sub-transistor and a second sub-transistor included in the inverter of FIG. 7 as switches;

FIG. 9 is a graph illustrating an input voltage and an output voltage of the inverter of FIG. 8;

FIG. 10 is a graph illustrating a gate voltage-drain current of the first sub-transistor and the second sub-transistor included in the inverter of FIG. 7;

FIG. 11 is a circuit diagram illustrating another example of the pixel circuit included in the display panel of FIG. 1;

FIG. 12 is a circuit diagram illustrating another example of the pixel circuit included in the display panel of FIG. 1;

FIG. 13 is a timing diagram illustrating an example of driving the pixel circuit in FIG. 11;

FIG. 14 is a block diagram illustrating an embodiment of an electronic device; and

FIG. 15 is a diagram illustrating an embodiment in which the electronic device of FIG. 14 is implemented as a smart watch.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the disclosure will be described in detail with reference to the accompanying drawings.

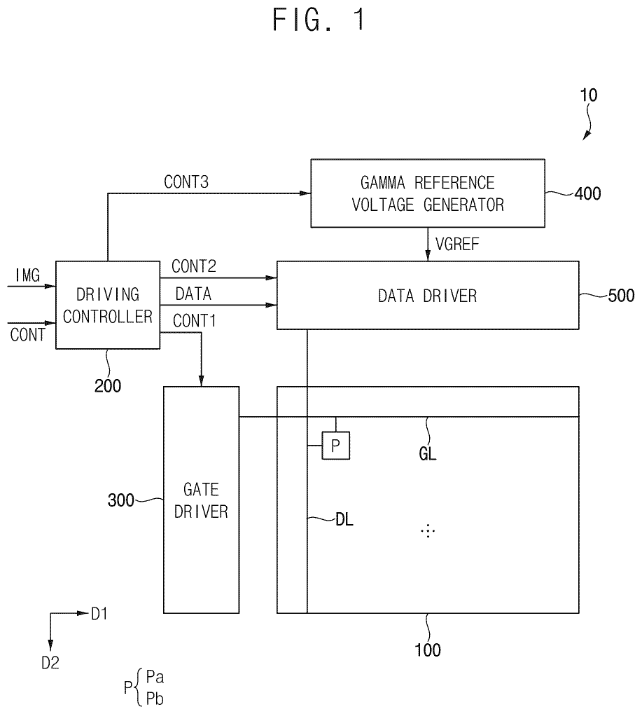

FIG. 1 is a block diagram illustrating a display device 10 according to embodiments of the invention.

Referring to FIG. 1, an embodiment of the display device 10 may include a display panel 100 and a display panel driver. The display panel driver may include a driving controller 200, a gate driver 300, a gamma reference voltage generator 400, a data driver 500.

The display panel 100 may include a display region for displaying an image and a peripheral region disposed adjacent to the display region.

The display panel 100 may include gate lines GL, data lines DL, and pixel circuits P electrically connected to the gate lines GL and the data lines DL, respectively. The gate lines GL may extend in a first direction D1, the data lines DL may extend in a second direction D2 crossing the first direction D1.

The driving controller 200 may receive input image data IMG and an input control signal CONT from an external device (not shown). In an embodiment, for example, the input image data IMG may include red image data, green image data and blue image data. The input image data IMG may include white image data. In another embodiment, for example, the input image data IMG may include magenta image data, yellow image data, and cyan image data. The input control signal CONT may include a master clock signal and a data enable signal. The input control signal CONT may further include a vertical synchronization signal and a horizontal synchronization signal.

The driving controller 200 may generate a first control signal CONT1, a second control signal CONT2, a third control signal CONT3, and a data signal DATA based on the input image data IMG and the input control signal CONT.

The driving controller 200 may generate the first control signal CONTI for controlling an operation of the gate driver 300 based on the input control signal CONT, and output the first control signal CONTI to the gate driver 300. The first control signal CONT1 may include a vertical start signal and a gate clock signal.

The driving controller 200 may generate the second control signal CONT2 for controlling an operation of the data driver 500 based on the input control signal CONT, and output the second control signal CONT2 to the data driver 500. The second control signal CONT2 may include a horizontal start signal and a load signal.

The driving controller 200 may generate the data signal DATA based on the input image data IMG. The driving controller 200 may output the data signal DATA to the data driver 500.

The driving controller 200 may generate the third control signal CONT3 for controlling an operation of the gamma reference voltage generator 400 based on the input control signal CONT, and output the third control signal CONT3 to the gamma reference voltage generator 400.

The gate driver 300 may generate gate signals for driving the gate lines GL in response to the first control signal CONTI received from the driving controller 200. The gate driver 300 may output the gate signals to the gate lines GL.

The gamma reference voltage generator 400 may generate a gamma reference voltage VGREF in response to the third control signal CONT3 received from the driving controller 200. The gamma reference voltage generator 400 may provide the gamma reference voltage VGREF to the data driver 500. The gamma reference voltage VGREF may have a value corresponding to each data signal DATA.

In an embodiment, for example, the gamma reference voltage generator 400 may be disposed in the driving controller 200 or may be disposed in the data driver 500.

The data driver 500 may receive the second control signal CONT2 and the data signal DATA from the driving controller 200, and receive the gamma reference voltage VGREF from the gamma reference voltage generator 400. The data driver 500 may convert the data signal DATA into a data voltage having an analog type using the gamma reference voltage VGREF. The data driver 500 may output the data voltage to the data line DL.

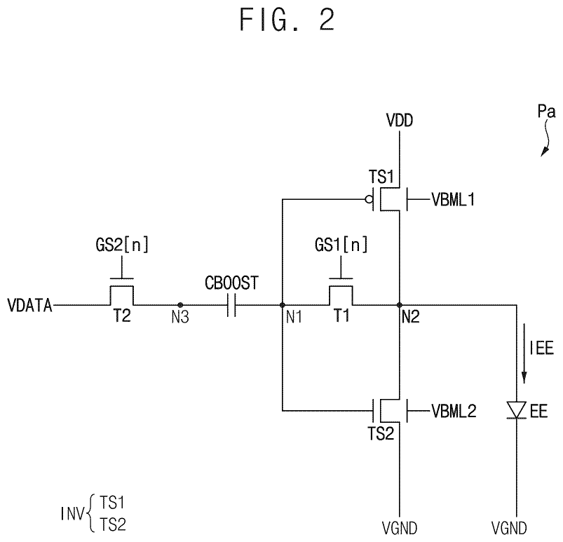

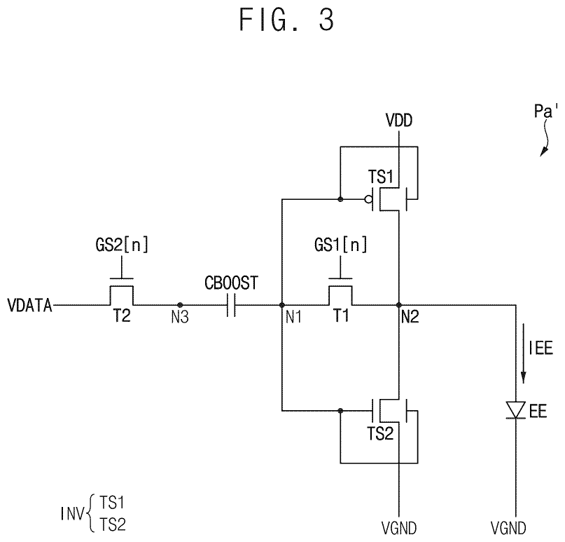

FIG. 2 is a circuit diagram illustrating an example Pa of the pixel circuit P included in the display panel 100 of FIG. 1. FIG. 3 is a circuit diagram illustrating another example Pa′ of the pixel circuit P included in the display panel 100 of FIG. 1.

Referring to FIGS. 1 to 3, an embodiment of the pixel circuit Pa may a first transistor T1 including a gate terminal that receives a first gate signal GS1[n], a first terminal connected to a first node N1, and a second terminal connected to a second node N2, an inverter INV including a first sub-transistor TS1 including a gate terminal connected to the first node N1, a first terminal that receives a driving voltage VDD, and a second terminal connected to the second node N2 and a second sub-transistor TS2 which includes a gate terminal connected to the first node N1, a first terminal that receives a ground voltage VGND, a second terminal connected to the second node N2, and a light emitting element EE including an anode connected to the second node N2 and a cathode that receives the ground voltage VGND. The first sub-transistor TS1 may be a P-type transistor and further include a back gate terminal that receives a first back gate voltage VBML1, and the second sub-transistor TS2 may be an N-type transistor and further include a back gate terminal that receives a second back gate voltage VBML2. In an embodiment, the P-type transistor may be a polysilicon thin-film transistor and the N-type transistor may be an oxide thin-film transistor.

The pixel circuit Pa may further include a second transistor T2 including a gate terminal that receives a second gate signal GS2[n], a first terminal that receives a data voltage VDATA, and a second terminal connected to a third node N3 and a boost capacitor CBOOST including a first terminal connected to the third node N3 and a second terminal connected to the first node N1. The data voltage VDATA may include a pulse width modulation (PWM) data voltage and a sweep voltage.

In an embodiment, the first gate signal GS1[n] and the second gate signal GS2[n] may be sequentially applied to the pixel circuits Pa on a row-by-row basis. That is, the pixel circuits Pa may emit a light sequentially.

In another embodiment, the first gate signal GS1[n] and the second gate signal GS2[n] may be applied substantially simultaneously to the pixel circuits Pa arranged in two or more rows. In an embodiment, for example, the first gate signal GS1[n] and the second gate signal GS2[n] may be applied to all pixel circuits Pa of the display panel 100 at substantially the same time. In such an embodiment, the pixel circuits Pa may emit the light simultaneously.

An input terminal of the inverter INV may be connected to the first node N1 and an output terminal of the inverter INV may be connected to the second node N2.

As shown in FIG. 3, in another embodiment, the back gate terminal of the first sub-transistor TS1 may be connected to the first node N1. That is, the first back gate voltage VBML1 may be a voltage of the first node N1. In such an embodiment, the back gate terminal of the second sub-transistor TS2 may be connected to the first node N1. That is, the second back gate voltage VBML2 may be the voltage of the first node N1.

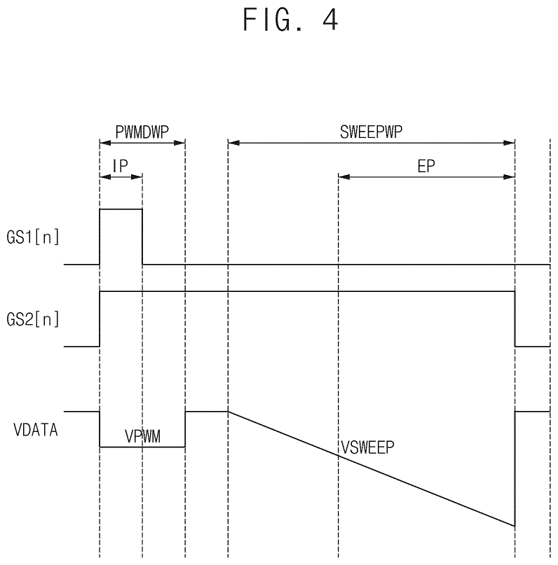

FIG. 4 is a timing diagram illustrating an example of driving the pixel circuit Pa of FIG. 2.

Referring to FIGS. 1 to 4, in an initialization period IP, the first transistor T1 may be turned on in response to a first gate signal GS1[n] having a high level. When the first transistor T1 is turned on, the first node N1 and the second node N2 may be initialized.

In a PWM data writing period PWMDWP, the second transistor T2 may be turned on in response to a second gate signal GS2[n] having the high level, and the second transistor T2 may provide the PWM data voltage VPWM to the third node N3.

In a sweep voltage writing period SWEEPWP, the second transistor T2 may be turned on in response to a second gate signal GS2[n] having the high level, and the second transistor T2 may provide the sweep voltage VSWEEP to the third node N3. Additionally, the first transistor T1 may be turned off in response to the first gate signal GS1[n] having the low level. The voltage of the first node N1 may be boosted by the sweep voltage VSWEEP by the boosting capacitor CBOOST.

A light emission period EP may be determined depending on a voltage level of the PWM data voltage VPWM. Specifically, when the PWM data voltage VPWM has a relatively high voltage level, the first sub-transistor TS1 may be turned off until the sweep voltage VSWEEP becomes a relatively low voltage level. The second sub-transistor TS2 may be turned on, and the inverter INV may provide the ground voltage VGND to the second node N2. Since the light emitting element EE emits the light in response to a voltage of the second node N2 having the driving voltage VDD (or driving current IEE), a light emission time may be relatively short.

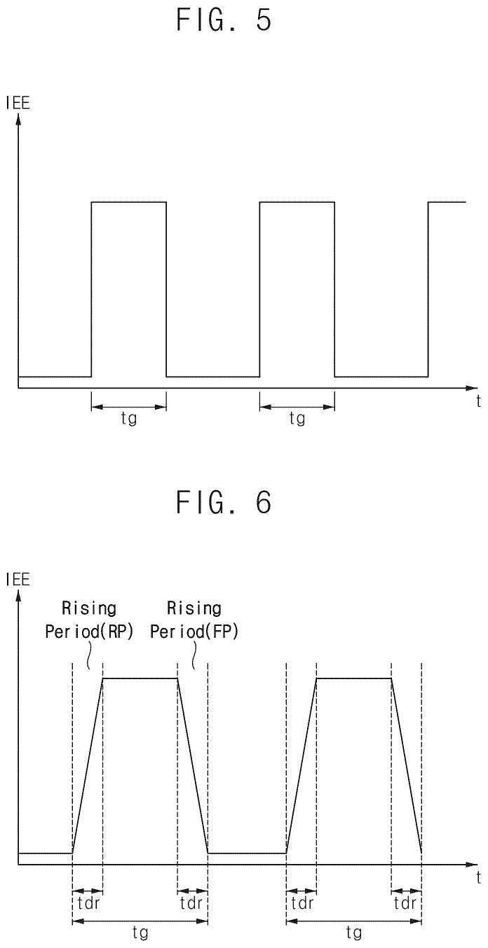

FIG. 5 is a graph illustrating an ideal example of the driving current IEE flowing into the light emitting element EE of FIG. 2. FIG. 6 is a graph illustrating an actual example of the driving current IEE flowing into the light emitting element EE of FIG. 2.

Referring to FIGS. 1 to 6, the second transistor T2 may apply the data voltage VDATA to the third node N3, and the boosting capacitor CBOOST may apply a voltage corresponding to the data voltage VDATA to the first node N1. The inverter INV may provide the driving voltage VDD or the ground voltage VGND to the second node N2 in response to the voltage of the first node N1. The light emitting element EE may emit the light in response to the voltage of the second node N2 having the driving voltage VDD (or the driving current IEE). A generation time tg of the driving current IEE may correspond to the light emission period EP.

The pixel circuit Pa may display an image using a PWM method. The PWM method may express the grayscale by adjusting the generation time tg of the driving current IEE. Therefore, in the PWM method, the generation time tg of the driving current IEE may be important to express the grayscale.

As shown in FIG. 5, when the driving current IEE does not include the delay time tdr, tdf, a reliability of the grayscale implemented by the pixel circuit Pa may be increased, and the driving current IEE may be ideal. However, the actual driving current IEE may include the delay times tdr, tdf, as shown in FIG. 6. As the delay time tdr, tdf of the driving current IEE is longer, the reliability of the grayscale implemented by the pixel circuit Pa may decrease.

In an embodiment, the pixel circuit Pa may include the inverter INV such that the delay time tdr, tdf of the driving current IEE may be reduced.

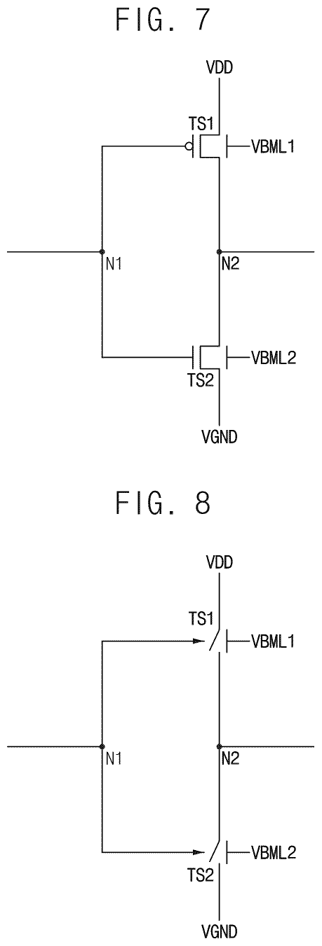

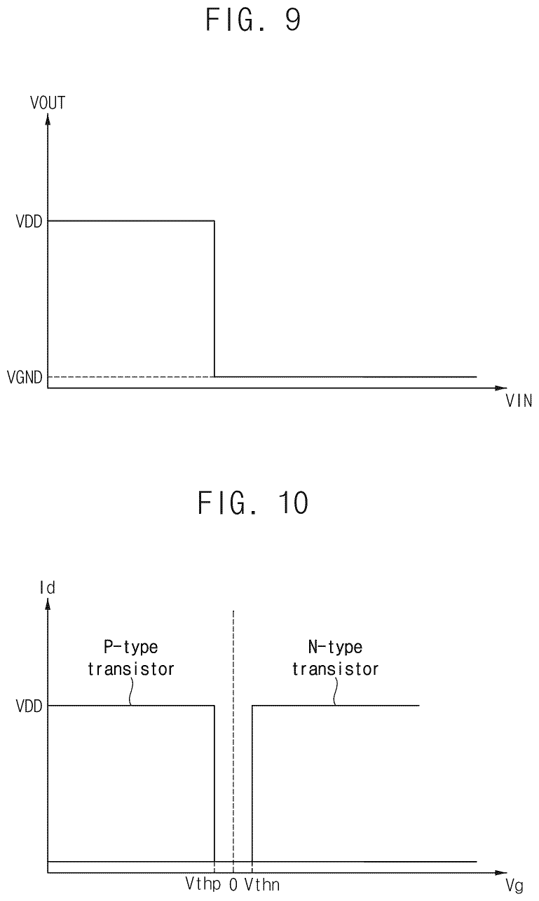

FIG. 7 is a circuit diagram illustrating the inverter INV of FIG. 2. FIG. 8 is a circuit diagram illustrating the first sub-transistor TS1 and the second sub-transistor TS2 included in the inverter INV of FIG. 7 as switches. FIG. 9 is a graph illustrating an input voltage VIN and an output voltage VOUT of the inverter INV of FIG. 8.

Hereinafter, an operation in which the pixel circuit Pa minimizes the delay time tdr, tdf of the driving current IEE by including the inverter INV may be described with reference to FIGS. 1 to 9.

As shown in FIG. 7, the inverter INV may include the first sub-transistor TS1 and the second sub-transistor TS2. As shown in FIG. 8, the first sub-transistor TS1 and the second sub-transistor TS2 may be expressed as the switches for convenience of description. In an embodiment, as described above, the first sub-transistor TS1 may be the P-type transistor and the second sub-transistor TS2 may be the N-type transistor. Therefore, when the voltage of the first node NI is less than a certain voltage, the first sub-transistor TS1 may be turned on and the second sub-transistor TS2 may be turned off. In this case, the driving voltage VDD may be applied to the second node N2. When the voltage of the first node N1 is greater than the certain voltage, the first sub-transistor TS1 may be turned off and the second sub-transistor TS2 may be turned on. In this case, the ground voltage VGND may be applied to the second node N2. As such, the inverter INV may invert the voltage of the first node N1 and output the inverted voltage of the first node N1 to the second node N2. The voltage of the first node N1 may be the input voltage VIN of the inverter INV, and the voltage of the second node N2 may be the output voltage VOUT of the inverter INV. Therefore, a relationship between the input voltage VIN of the inverter INV and the output voltage VOUT of the inverter INV depending on the operation of the inverter INV may be shown in FIG. 9.

The inverter INV may control the voltage of the first node N1 and the voltage of the second node N2. Therefore, the pixel circuit Pa may include the inverter INV, such that the delay time tdr of the rising period RP of the driving current IEE and the delay time tdf of the falling period FP of the driving current IEE may be reduced.

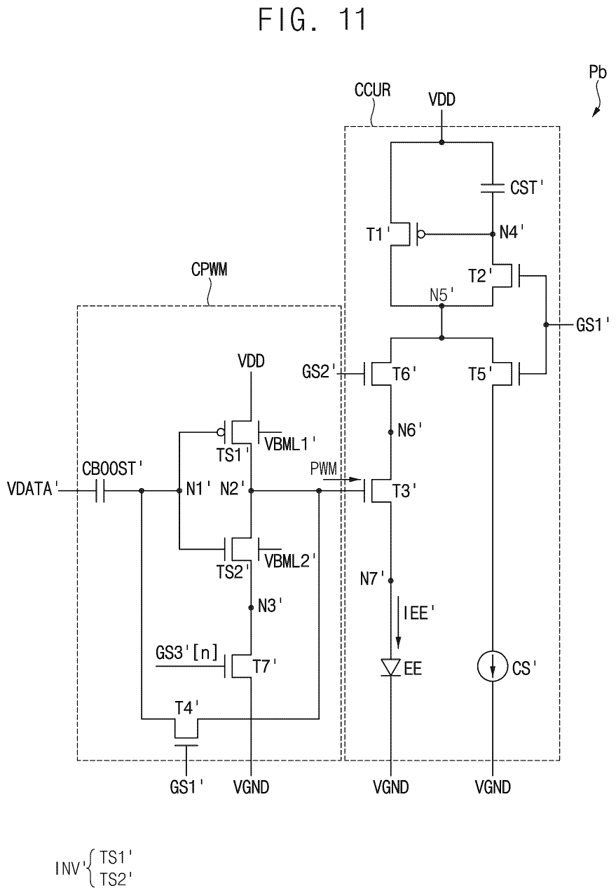

FIG. 10 is a graph illustrating a gate voltage-drain current of the first sub-transistor TS1 and the second sub-transistor TS2 included in the inverter INV of FIG. 7.

Referring to FIGS. 1 to 10, as described above, the operation of the inverter INV may be determined based on the certain voltage. However, this is when the operation of the inverter INV is ideal, and actual operation may be different from this.

A transistor may be turned on or off based on a threshold voltage. As shown in FIG. 10, generally, a threshold voltage Vthp of the P-type transistor may have a negative value and a threshold voltage Vthn of the N-type transistor may have a positive value. Since the first sub-transistor TS1 is the P-type transistor and the second sub-transistor TS2 is the N-type transistor, the threshold voltage of the first sub-transistor TS1 and the threshold voltage of the second sub-transistor TS2 may be different from each other, and accordingly, a voltage at which the first sub-transistor TS1 is turned on and a voltage at which the second sub-transistor TS2 is turned on may be different from each other. Therefore, the actual operation of the inverter INV may be different from that described in FIGS. 7 to 9.

In an embodiment, a difference between the threshold voltage of the first sub-transistor TS1 and the threshold voltage of the second sub-transistor TS2 may be reduced in order for the operation of the inverter INV to be similar to that described in FIGS. 7 to 9. The threshold voltage of the transistor may be determined based on a back gate voltage of the transistor. When a back gate voltage of the P-type transistor decreases, the threshold voltage of the P-type transistor may increase. When a back gate voltage of the N-type transistor increases, the threshold voltage of the N-type transistor may decrease. Therefore, the threshold voltage of the first sub-transistor TS1 may be determined based on the first back gate voltage VBML1, and the threshold voltage of the second sub transistor TS2 may be determined based on the second back gate voltage VBML2. When the first back gate voltage VBML1 decreases, the threshold voltage of the first sub-transistor TS1 may increase. When the second back gate voltage VBML2 increases, the threshold voltage of the second sub-transistor TS2 may decrease.

When the difference between the threshold voltage of the first sub-transistor TS1 and the threshold voltage of the second sub-transistor TS2 decreases, the delay time of the rising period RP of the driving current IEE tdr and the delay time tdf of the falling period FP may be reduced. In an embodiment, the difference of the threshold voltage of the first sub-transistor TS1 and the threshold voltage of the second sub-transistor TS2 may be reduced by adjusting the first back gate voltage VBML1 and/or the second back gate voltage VBML2 such that the delay time of the rising period RP of the driving current IEE tdr and the delay time tdf of the falling period FP may be reduced.

In an embodiment, as described above, the pixel circuit Pa may include the inverter INV such that the delay time tdr of the rising period RP of the driving current IEE and the delay time tdf of the falling period FP of the driving current IEE may be reduced. The pixel circuit Pa may adjust the first back gate voltage VBLM1 of the first sub-transistor TS1 included in the inverter INV and the second back gate voltage VBML2 of the second sub-transistor TS2 included in the inverter INV such that the delay time tdr of the rising period RP and/or the delay time tdf of the falling period FP of the driving current IEE may be further reduced. Accordingly, the reliability of the grayscale implemented by the pixel circuit Pa which displays the image using the PWM method may be increased.

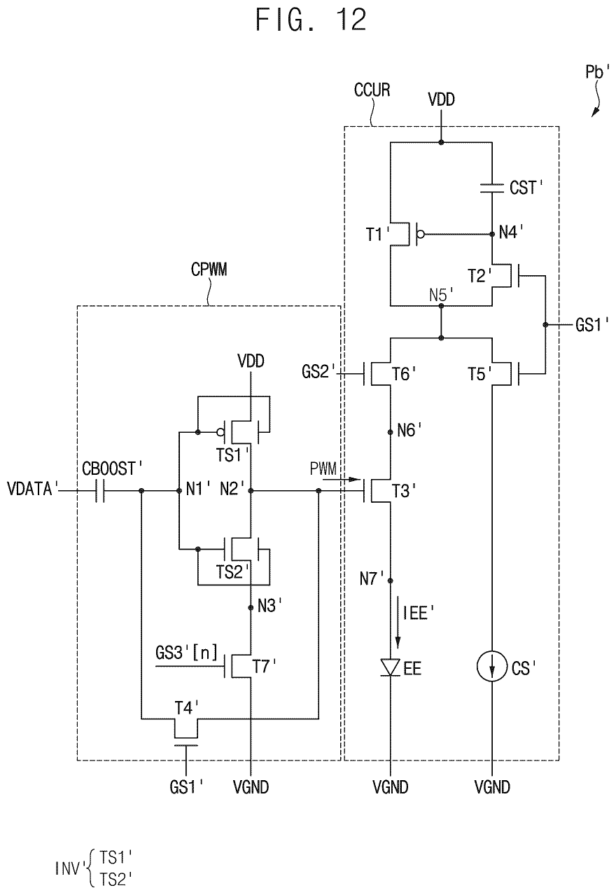

FIG. 11 is a circuit diagram illustrating another example Pb of the pixel circuit P included in the display panel 100 of FIG. 1. FIG. 12 is a circuit diagram illustrating another example Pb′ of the pixel circuit P included in the display panel 100 of FIG. 1.

The inverter INV of FIG. 2 and an inverter INV′ of FIG. 11 may be substantially the same as each other in that the reliability of the grayscale implemented by the pixel circuit may increase by reducing the delay time of the driving current by adjusting the back gate voltage. Therefore, any repetitive detailed descriptions of the same or like contents as those described above will be omitted.

Referring to FIGS. 1 to 12, an embodiment of the pixel circuit Pb may include a pulse width modulation circuit CPWM configured to generate a pulse width modulation signal PWM and including a first sub-transistor TS1′ which includes a gate terminal connected to a first node N1′, a first terminal that receives a driving voltage VDD, and a second terminal connected to a second node N2′ and a second sub-transistor TS2′ including a gate terminal connected to the first node N1′, a first terminal connected a third node N3′, and a second terminal connected to the second node N2′ and a driving current generating circuit CCUR configured to generate a driving current IEE′ whose a generation time is determined based on the pulse width modulation signal PWM and including a light emitting element EE which emits a light based on the driving current IEE′. The first sub-transistor TS1′ may be a P-type transistor and further include a back gate terminal that receives a first back gate voltage VBML1′, and the second sub-transistor TS2′ may be an N-type transistor and further include a back gate terminal that receives a second back gate voltage VBML2′. In an embodiment, the P-type transistor may be a polysilicon thin-film transistor and the N-type transistor may be an oxide thin-film transistor.

The driving current generating circuit CCUR may further include a first transistor T1′ including a gate terminal connected a fourth node N4′, a first terminal that receives the driving voltage VDD, and a second terminal connected to a fifth node N5′, a second transistor T2′ including a gate terminal that receives a first gate signal GS1′, a first terminal connected to the fourth node N4′, and a second terminal connected to the fifth node N5′, and a third transistor T3′ including a gate terminal that receives the pulse width modulation signal PWM output from the second node N2′, a first terminal connected to a sixth node N6′, and a second terminal connected a seventh node N7′.

The pulse width modulation circuit CPWM may further include a fourth transistor T4′ including a gate terminal that receives the first gate signal GS1′, a first terminal connected to the first node N1′, and a second terminal connected to the second node N2′.

The light emitting element EE may include an anode connected to the seventh node N7′ and a cathode that receives a ground voltage VGN.

The driving current generating circuit CCUR may further include a fifth transistor T5′ including a gate terminal that receives the first gate signal GS1′, a first terminal connected to a current source CS′, and a second terminal connected to the fifth node N5′, a sixth transistor T6′ including a gate terminal that receives a second gate signal GS2′, a first terminal connected to the fifth node N5′, and a second terminal connected to the sixth node N6′, and a storage capacitor CST′ including a first terminal that receives the driving voltage VDD and a second terminal connected to the fourth node N4′.

The pulse width modulation circuit CPWM may further include a seventh transistor T7′ including a gate terminal that receives a third gate signal GS3′[n], a first terminal that receives the ground voltage VGND, a second terminal connected to the third node N3′ and a boost capacitor CBOOST′ including that receives a data voltage VDATA′ and a second terminal connected to the first node N1′. The data voltage VDATA′ may include a PWM data voltage and a sweep voltage.

In an embodiment, the first gate signal GS1′ and the second gate signal GS2′ may be applied substantially simultaneously to the pixel circuits Pb arranged in two or more rows. In an embodiment, for example, the first gate signal GS1′ and the second gate signal GS2′ may be applied to all pixel circuits Pb of the display panel 100 at substantially the same time.

In an embodiment, the third gate signal GS3′[n] may be sequentially applied to the pixel circuits Pb on a row-by-row basis.

As shown in FIG. 12, in another embodiment, the back gate terminal of the first sub-transistor TS1′ may be connected to the first node N1′. That is, the first back gate voltage VBML1′ may be a voltage of the first node N1. Additionally, in an embodiment, the back gate terminal of the second sub-transistor TS2′ may be connected to the first node N1′. That is, the second back gate voltage VBML2′ may be the voltage of the first node N1.

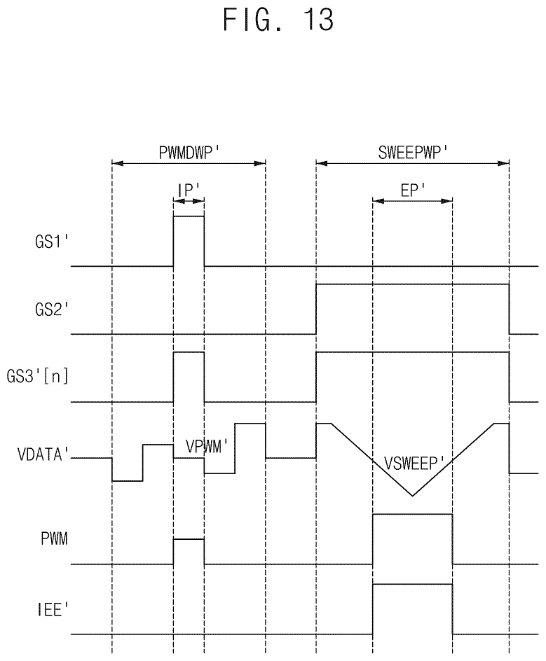

FIG. 13 is a timing diagram illustrating an example of driving the pixel circuit Pb in FIG. 11.

Referring to FIGS. 1 to 13, in an initialization period IP′, the fourth transistor T4′ may be turned on in response to a first gate signal GS1′ having a high level. When the fourth transistor T4 is turned on, the first node N1′ and the second node N2′ may be initialized. Additionally, the seventh transistor T7′ may be turned on in response to the third gate signal GS3′[n] having the high level. When the seventh transistor T7′ is turned on, the seventh transistor T7′ may provide the ground voltage VGND to the inverter INV′ to control an operation of the inverter INV′.

In a PWM data writing period PWMDWP′, the PWM data voltage VPWM′ may be provided to the first terminal of the sweeping capacitor CSW′.

In a sweep voltage writing period SWEEPWP′, the sweep voltage VSWEEP′ may be provided to the first terminal of the sweeping capacitor CSW′. A voltage of the first node N1 may be boosted by the sweep voltage VSWEEP′ by the boosting capacitor CBOOST.

A pulse width of the pulse width modulation signal PWM may be determined depending on a voltage level of the PWM data voltage VPWM′. Specifically, when the PWM data voltage VPWM′ has a relatively high voltage level, the first sub-transistor TS1′ may be turned off, the second sub-transistor TS2 may be turned on, and the inverter INV may provide the ground voltage VGND to the second node N2′ until the sweep voltage VSWEEP′ becomes a relatively low voltage level. Therefore, the pulse width of the pulse width modulation signal PWM may be relatively short.

The second transistor T2′ and the fifth transistor T5′ may be turned on in response to the first gate signal GS1′ having the high level. The second transistor T2′ may connect the fourth node N4′ and the fifth node N5′ to compensate for a threshold voltage of the first transistor T1′. The current source CS′ may provide a constant current to the fifth node N5′ and the fourth node N4′. The first transistor T1′ may generate the driving current IEE′.

The third transistor T3′ may be turned on in response to the pulse width modulation signal PWM. The third transistor T3′ may provide the driving current IEE′ to the light emitting element EE. Therefore, a light emission period EP′ may be determined depending on the pulse width of the pulse width modulation signal PWM. That is, the generation time of the driving current IEE′ may be determined based on the pulse width modulation signal PWM.

A threshold voltage of the first sub-transistor TS1′ may be determined based on the first back gate voltage VBML1′, and a threshold voltage of the second sub-transistor TS2′ may be determined based on the second back gate voltage VBML2′. When a difference between the threshold voltage of the first sub-transistor TS1′ and the threshold voltage of the second sub-transistor TS2′ decreases, the inverter INV′ may reduce a delay time of a rising period of the pulse width modulation signal PWM and a delay time of a falling period of the pulse width modulation signal PWM.

When the difference between the threshold voltage of the first sub-transistor TS1′ and the threshold voltage of the second sub-transistor TS2′ decreases, the delay time of the rising period of the driving current IEE′ and the delay time of the falling period of the driving current IEE′ may be reduced.

In an embodiment, as described above, the pixel circuit Pb may include the inverter INV′ such that the delay time of the rising period of the driving current IEE′ and the delay time of the falling period of the driving current IEE′ may be reduced. The pixel circuit Pb may adjust the first back gate voltage VBML1′ of the first sub-transistor TS1′ included in the inverter INV′ and the second back gate voltage VBML2′ of the second sub-transistor TS2′ included in the inverter INV′ such that the delay time of the rising period and/or the delay time of the falling period of the driving current IEE′ may be further reduced. Accordingly, a reliability of the grayscale implemented by the pixel circuit Pb which displays an image using a pulse width modulation method may be increased.

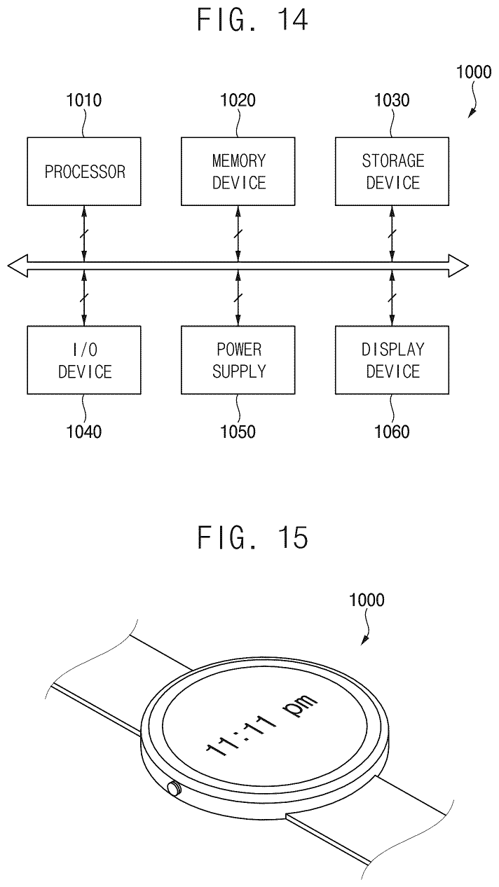

FIG. 14 is a block diagram illustrating an embodiment of an electronic device 1000. FIG. 15 is a diagram illustrating an embodiment in which the electronic device 1000 of FIG. 14 is implemented as a smart watch.

Referring to FIGS. 14 and 15, an embodiment of the electronic device 1000 may include a processor 1010, a memory device 1020, a storage device 1030, an input/output (I/O) device 1040, a power supply 1050, and a display device 1060. The display device 1060 may be the display device 10 of FIG. 1. In addition, the electronic device 1000 may further include a plurality of ports for communicating with a video card, a sound card, a memory card, a universal serial bus (USB) device, other electronic device, and the like.

In an embodiment, as illustrated in FIG. 15, the electronic device 1000 may be implemented as the smart watch. However, the electronic device 1000 is not limited thereto. In an embodiment, for example, the electronic device 1000 may be implemented as a cellular phone, a video phone, a smart pad, a smart watch, a tablet computer, a car navigation system, a computer monitor, a laptop, a head mounted display (HMD) device, or the like.

The processor 1010 may perform various computing functions. The processor 1010 may be a micro processor, a central processing unit (CPU), an application processor (AP), or the like. The processor 1010 may be coupled to other components via an address bus, a control bus, a data bus, or the like. Further, the processor 1010 may be coupled to an extended bus such as a peripheral component interconnection (PCI) bus.

The memory device 1020 may store data for operations of the electronic device 1000. In an embodiment, for example, the memory device 1020 may include at least one non-volatile memory device such as an erasable programmable read-only memory (EPROM) device, an electrically erasable programmable read-only memory (EEPROM) device, a flash memory device, a phase change random access memory (PRAM) device, a resistance random access memory (RRAM) device, a nano floating gate memory (NFGM) device, a polymer random access memory (PoRAM) device, a magnetic random access memory (MRAM) device, a ferroelectric random access memory (FRAM) device, or the like and/or at least one volatile memory device such as a dynamic random access memory (DRAM) device, a static random access memory (SRAM) device, a mobile DRAM device, or the like.

The storage device 1030 may include a solid state drive (SSD) device, a hard disk drive (HDD) device, a CD-ROM device, or the like.

The I/O device 1040 may include an input device such as a keyboard, a keypad, a mouse device, a touch-pad, a touch-screen, and the like, and an output device such as a printer, a speaker, or the like. In some embodiments, the I/O device 1040 may include the display device 1060.

The power supply 1050 may provide power for operations of the electronic device 1000.

The display device 1060 may be connected to other components through buses or other communication links.

The inventions may be applied to any display device and any electronic device including the touch panel, for example, a mobile phone, a smart phone, a tablet computer, a digital television (TV), a three-dimensional (3D) TV, a personal computer (PC), a home appliance, a laptop computer, a personal digital assistant (PDA), a portable multimedia player (PMP), a digital camera, a music player, a portable game console, a navigation device, etc.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. A pixel circuit comprising:
a first transistor including a gate terminal which receives a first gate signal, a first terminal connected to a first node, and a second terminal connected to a second node;
an inverter including:
a first sub-transistor including a gate terminal connected to the first node, a first terminal which receives a driving voltage, and a second terminal connected to the second node; and
a second sub-transistor which includes a gate terminal connected to the first node, a first terminal which receives a ground voltage, a second terminal connected to the second node; and
a light emitting element including an anode connected to the second node and a cathode which receives the ground voltage,
wherein the first sub-transistor is a P-type transistor and further includes a back gate terminal which receives a first back gate voltage, and
wherein the second sub-transistor is an N-type transistor and further includes a back gate terminal which receives a second back gate voltage.

2. The pixel circuit of claim 1, wherein each of the first back gate voltage and the second back gate voltage is equal to a voltage of the first node.

3. The pixel circuit of claim 1, further comprising:
a second transistor including a gate terminal which receives a second gate signal, a first terminal which receives a data voltage including a pulse width modulation data voltage and a sweep voltage, and a second terminal connected to a third node; and
a boost capacitor including a first terminal connected to the third node and a second terminal connected to the first node.

4. The pixel circuit of claim 3, wherein an input terminal of the inverter is connected to the first node and an output terminal of the inverter is connected to the second node.

5. The pixel circuit of claim 4, wherein a driving current is generated based on the data voltage and a generation time of the driving current is determined depending on a voltage level of the pulse width modulation data voltage.

6. The pixel circuit of claim 5, wherein the inverter inverts a voltage of the first node and outputs an inverted voltage of the first node to the second node.

7. The pixel circuit of claim 5, wherein the inverter reduces a delay time of a rising period of the driving current and a delay time of a falling period of the driving current.

8. The pixel circuit of claim 1, wherein a threshold voltage of the first sub-transistor is determined based on the first back gate voltage and a threshold voltage of the second sub-transistor is determined based on the second back gate voltage.

9. The pixel circuit of claim 8, wherein the threshold voltage of the first sub-transistor increases when the first back gate voltage decreases.

10. The pixel circuit of claim 8, wherein the threshold voltage of the second sub-transistor decreases when the second back gate voltage increases.

11. The pixel circuit of claim 8, wherein a delay time of a rising period of the driving current and a delay time of a falling period of the driving current decrease when a difference between the threshold voltage of the first sub-transistor and the threshold voltage of the second sub-transistor decreases.

12. The pixel circuit of claim 1, wherein the P-type transistor is a polysilicon thin-film transistor and the N-type transistor is an oxide thin-film transistor.

13. A pixel circuit comprising:
a pulse width modulation circuit which generates a pulse width modulation signal, wherein the pulse width modulation circuit includes an inverter including:
a first sub-transistor including a gate terminal connected to a first node, a first terminal which receives a driving voltage, and a second terminal connected to a second node; and
a second sub-transistor including a gate terminal connected to the first node, a first terminal connected a third node, and a second terminal connected to the second node; and
a driving current generating circuit which generates a driving current whose a generation time is determined based on the pulse width modulation signal, wherein the driving current generating circuit includes a light emitting element which emits a light based on the driving current,
wherein the first sub-transistor is a P-type transistor and further includes a back gate terminal which receives a first back gate voltage, and
wherein the second sub-transistor is an N-type transistor and further includes a back gate terminal which receives a second back gate voltage.

14. The pixel circuit of claim 13, wherein each of the first back gate voltage and the second back gate voltage is equal to a voltage of the first node.

15. The pixel circuit of claim 12,
wherein the driving current generating circuit further includes:
a first transistor including a gate terminal connected a fourth node, a first terminal which receives the driving voltage, and a second terminal connected to a fifth node;
a second transistor including a gate terminal which receives a first gate signal, a first terminal connected to the fourth node, and a second terminal connected to the fifth node; and
a third transistor including a gate terminal which receives the pulse width modulation signal output from the second node, a first terminal connected to a sixth node, and a second terminal connected a seventh node,
wherein the pulse width modulation circuit further includes:
a fourth transistor including a gate terminal which receives the first gate signal, a first terminal connected to the first node, and a second terminal connected to the second node, and
wherein the light emitting element includes an anode connected to the seventh node and a cathode which receives a ground voltage.

16. The pixel circuit of claim 15,
wherein the driving current generating circuit further includes:
a fifth transistor including a gate terminal which receives the first gate signal, a first terminal connected to a current source, and a second terminal connected to the fifth node;
a sixth transistor including a gate terminal which receives a second gate signal, a first terminal connected to the fifth node, and a second terminal connected to the sixth node; and
a storage capacitor including a first terminal which receives the driving voltage and a second terminal connected to the fourth node,
wherein the pulse width modulation circuit further includes:
a seventh transistor including a gate terminal which receives a third gate signal, a first terminal which receives the ground voltage, a second terminal connected to the third node; and
a boost capacitor including which receives a data voltage and a second terminal connected to the first node.

17. The pixel circuit of claim 13, wherein an input terminal of the inverter is connected to the first node and an output terminal of the inverter is connected to the second node.

18. The pixel circuit of claim 17, wherein the inverter inverts a voltage of the first node and output an inverted voltage of the first node to the second node.

19. The pixel circuit of claim 18, wherein the inverter reduces a delay time of a rising period of the driving current and a delay time of a falling period of the driving current.

20. The pixel circuit of claim 13, wherein a threshold voltage of the first sub-transistor is determined based on the first back gate voltage and a threshold voltage of the second sub-transistor is determined based on the second back gate voltage.

21. The pixel circuit of claim 20, wherein a delay time of a rising period of the driving current and a delay time of a falling period of the driving current decrease when a difference between the threshold voltage of the first sub-transistor and the threshold voltage of the second sub-transistor decreases.

22. The pixel circuit of claim 13, wherein the P-type transistor is a polysilicon thin-film transistor and the N-type transistor is an oxide thin-film transistor.
